(19) United States
(12) Patent Application Publication
(10) Pub. No.: US 2016/0218992 A1
(43) Pub. Date: Jul. 28, 2016

(54) METHOD AND SYSTEM FOR COMMUNICATING USING CONSTRAINED APPLICATION PROTOCOL

(71) Applicant: Electronics and Telecommunications Research Institute, Daejeon (KR)

(72) Inventors: Yong Geun HONG, Daejeon (KR); Young Hwan CHOI, Daejeon (KR); Do Hyeun KIM, Jeju-si (KR); Hyoung Jun KIM, Daejeon (KR); Myung Ki SHIN, Seoul (KR)

(21) Appl. No.: 14/791,976

(22) Filed: Jul. 6, 2015

(30) Foreign Application Priority Data
Jan. 27, 2015 (KR) 10-2015-0012700

(51) Int. Cl. H04L 12/911

(52) U.S. Cl. CPC H04L 47/70

(57) ABSTRACT

Provided is a constrained application protocol (CoAP) communication method and a system for performing the method, wherein the method includes receiving a POST message for a registration request, verifying whether the registration request is valid in response to the POST message, extracting a unit identifier (ID) of at least one resource associated with a node from a message payload of the POST message, and returning a response message.

### CROSS-REFERENCE TO RELATED APPLICATION

This application claims the priority benefit of Korean Patent Application No. 10-2015-0012700, filed on Jan. 27, 2015, in the Korean Intellectual Property Office, the disclosure of which is incorporated herein by reference.

### BACKGROUND

1. Field of the Invention

The present invention relates to a constrained application protocol (CoAP) communication method and a system for performing the CoAP communication method.

2. Description of the Related Art

A constrained application protocol (CoAP) is a representational state transfer (REST) based protocol which is associated with a method of asynchronously transmitting, to a node, an event received and transmitted among resource-constrained machine-to-machine (M2M) nodes in an upper application layer including a transport layer including a user datagram protocol (UDP).

M2M technology provides a resource-oriented group communication method. An M2M application server, an M2M platform, an M2M terminal, an M2M gateway, and all data objects and local applications which are run on the M2M terminal and the M2M gateway are considered REST resources and identified by a uniform resource identifier (URI).

### SUMMARY

An aspect of the present invention provides technology for allowing individual resources to be separately accessed without a need for a node including a plurality of integrated sub-unit resources to have separate Internet Protocol (IP) addresses for the individual resources, but to request only a single IP address and use the IP address and a unit identifier (ID) pair.

Another aspect of the present invention also provides a single constrained application protocol (CoAP) message including a unit ID to be used for controlling sub-devices.

Still another aspect of the present invention also provides technology for reducing a traffic flow among clients and terminals and saving energy in constrained devices by using a composite message for a unit ID.

According to an aspect of the present invention, there is provided a CoAP communication method including receiving a POST message for a registration request, verifying whether the registration request is valid in response to the POST message, and extracting a unit ID of at least one resource associated with a node from a message payload of the POST message and returning a response message.

The returning of the response message may include generating a resource location of the at least one resource, and returning a uniform resource identifier (URI) as the response message.

The verifying may include requesting an IP address and a port number of the node in response to a validity of the registration request being verified.

According to another aspect of the present invention, there is provided a CoAP communication method including receiving a GET request including a resource type, verifying whether the GET request is valid in response to the GET request, and obtaining IDs of registered resources corresponding to the resource type.

The CoAP communication method may further include returning a response message including a list of the IDs of the registered resources and a node IP address of a node including the registered resources.

According to still another aspect of the present invention, there is provided a CoAP communication method including selecting a unit ID of at least one resource from a list, generating the unit ID and a token pair, and transmitting a GET request to the resource using an URI.

The CoAP communication method may further include obtaining a node IP address and a port number of a node including the at least one resource.

The GET request may include the node IP address, the port number, and the unit ID.

The GET request may further include a unit size associated with a number of the at least one resource.

The CoAP communication method may further include receiving an acknowledgement (ACK) including data and a token transmitted from the resource, and verifying a source of the data by comparing the token of the ACK to the unit ID and the token pair.

The CoAP communication method may further include verifying a validity of the request and transmitting the ACK including the data and the token.

According to yet another aspect of the present invention, there is provided a CoAP node including a control module configured to select a unit ID of at least one resource from a list, and generate the unit ID and a token pair and generate a GET request, and a communication module configured to transmit the GET request.

The control module may obtain a node IP address and a port number of a node including the at least one resource.

The GET request may include the node IP address, the port number, and the unit ID.

The GET request may further include a unit size associated with a number of the at least one resource.

The control module may receive an ACK including data and a token transmitted from the resource, and verify a source of the data by comparing the token of the ACK to the unit ID and the token pair.

According to further another aspect of the present invention, there is provided a communication system including a node configured to transmit a POST message for a registration request, and a resource directory configured to verify whether the registration request is valid in response to the POST message, extract a unit ID of at least one resource associated with the node from a message payload of the POST message, and register the node and the at least one resource.

The resource directory may generate a resource location of the at least one resource, and return an URI as a response message.

The resource directory may request a node IP address and a port number of the node in response to a validity of the registration request being verified.

According to still another aspect of the present invention, there is provided a communication system including a client configured to transmit a GET request including a resource type, and a resource directory configured to verify whether the GET request is valid in response to the GET request, and obtain IDs of registered resources corresponding to the resource type.

The resource directory may return a response message including a list of the IDs of the registered resources and a node IP address of a node including the registered resources.

According to still another aspect of the present invention, there is provided a CoAP message header including a field including version information, type information, and length information of a CoAP message, and an option section including a unit ID field representing at least one resource associated with a node.

The option section may further include a unit size field representing a number of the at least one resource.

The unit ID field may repeat by the number of the at least one resource of the unit size field.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a communication system according to an embodiment of the present invention;

FIG. 2 is a diagram illustrating an example of usage of a multi-identifier (ID) node-based constrained application protocol (CoAP) resource directory according to an embodiment of the present invention;

FIG. 3 is a diagram illustrating an example of an operation of identifying and controlling resources of a composite node using a unit ID according to an embodiment of the present invention;

FIG. 4 is a data flow illustrating an example of message exchange between the CoAP client and the composite node of FIG. 3;

FIG. 5 is a diagram illustrating an example of an Internet Protocol (IP) and ID mapping based on a plurality of unit IDs according to an embodiment of the present invention;

FIG. 6 is a diagram illustrating an example of a configuration of the client of FIG. 1;

FIG. 7 is a diagram illustrating an example of a format of a CoAP message header according to an embodiment of the present invention;

FIG. 8 is a diagram illustrating an example of registering a resource of a node in a resource directory according to an embodiment of the present invention;

FIG. 9 is a diagram illustrating an example of a lookup process of a resource directory to be performed on an endpoint unit resource integrated into a single node, for example, a single IP address, according to an embodiment of the present invention;

FIG. 10 is a diagram illustrating an example of interaction between a client and a resource, for example, a CoAP server, according to an embodiment of the present invention; and

FIG. 11 is a diagram illustrating another example of interaction between a client and a resource, for example, a CoAP server, according to an embodiment of the present invention.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

A term, “module,” described herein may refer to hardware that may perform a function and an operation to be described hereinafter according to each name of a module. Alternatively, the term “module” may refer to a computer program code that may execute a function and an operation, or an electronic recording medium, for example, a processor, including the computer program code that may execute a function and an operation.

Thus, the term “module” may refer to hardware to implement technical features of the present invention and/or a functional and/or structural combination of software to execute the hardware. Each module may be referred to as a device.

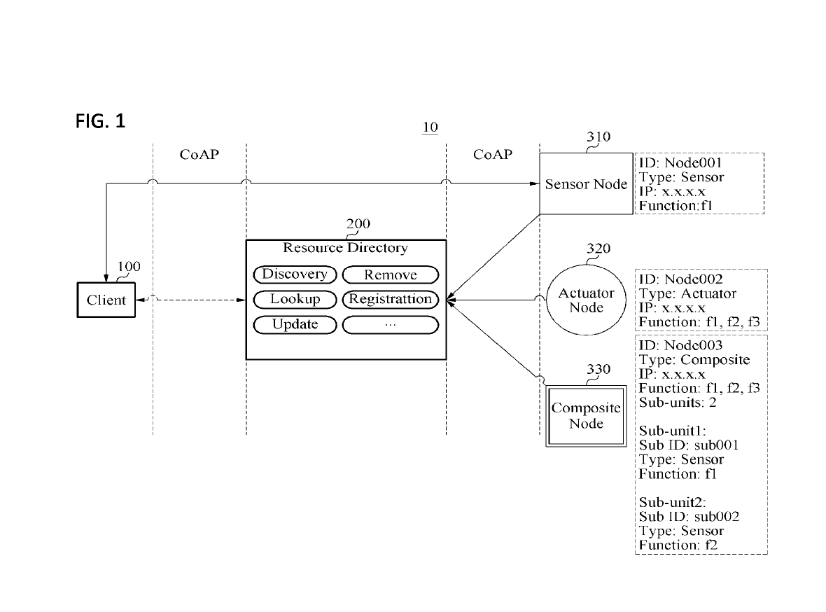

FIG. 1 is a diagram illustrating an example of a communication system 10 according to an embodiment of the present invention.

Referring to FIG. 1, the communication system 10 includes a client 100, a resource directory 200, and a plurality of nodes, for example, a sensor node 310, an actuator node 320, and a composite node 330.

The communication systems 10 may be a system to which a constrained application protocol (CoAP) is applied. The CoAP may be a protocol intended towards devices constrained in terms of memory, processing, and power, for example, small-sized low-power sensors, switches, and valves. The CoAP may allow such devices to communicate among one another through the Internet.

The client 100 may also be referred to as a CoAP client or a CoAP node.

The nodes may include, for example, the sensor node 310, the actuator node 320, and the composite node 330.

The sensor node 310 and the actuator node 320 may include a single resource, for example, a sensor and an actuator, respectively.

The composite node 330 may include a plurality of integrated resources, for example, a plurality of sensors and a plurality of actuators, or sensors and actuators.

Each node, for example, the sensor node 310, the actuator node 320, and the composite node 330, may have a node identifier (ID).

Devices of each node may be separately identified through a unit ID. For example, a unit ID for a resource may be unique among all integrated resources in a single node, and an identical unit ID may represent integrated resources in another node.

The integrated resources in the single node may be separately identified by a node ID and a unit ID. For example, integrated resources in the composite node 330 may be separately identified by a node ID and a unit ID.

Each node, for example, the sensor node 310, the actuator node 320, and the composite node 330, may have a single Internet Protocol (IP) address, and communicate with the client 100 and/or another module in the communication system 100, for example, the resource directory 200.

The unit ID used to identify individual integrated resources may be included in a unit ID option in a CoAP message.

The unit ID option in the CoAP message may enable usage of the composite node 330 including the sensors and actuators while having a single IP address for communication.

The integrated resources may individually or collectively communicate using the CoAP message including an additional option of a unit size (UnitSize) and a unit ID (UnitID), for example, the unit ID option, and be controlled using the CoAP message.

The UnitSize may be a numerical value indicating a number of sub-resources in the composite node 330, and the UnitID may have a string ID for a sub-resource for which the message is intended.

Such options may enable the CoAP to communicate and control a plurality of resources by using a single composite message, for example, UnitID=“*”, and efficiently utilize IP addresses, for example, one IP multiple IDs, reduce communication traffic, and hence conserve power among such CoAP resources.

Each node, for example, the sensor node 310, the actuator node 320, and the composite node 330, may register such resources in the resource directory 200.

The resource directory 200 may define a set of functions, for example, discovery, registration, lookup, and the like.

When each node, for example, the sensor node 310, the actuator node 320, and the composite node 330, registers all integrated resources of each node in the resource directory 200, the client 100 may look up a single resource or a plurality of resources, and directly interact with such resources.

The resource directory 200 may enable automated discovery and lookup of resources, and a plurality of unit IDs may provide efficient utilization of a single IP for interaction with the resources.

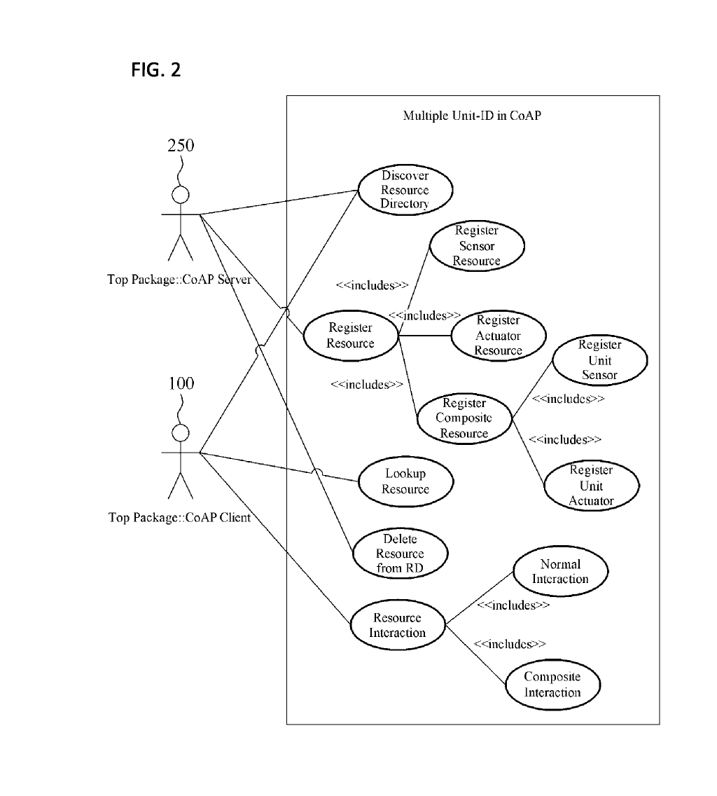

FIG. 2 is a diagram illustrating an example of usage of a multi-ID node-based CoAP resource directory according to an embodiment of the present invention.

Referring to FIGS. 1 and 2, the communication system 10 further includes a CoAP server 250.

The CoAP server 250 may operate as the CoAP client 100, and also operate as a reverse actor when such entities, the CoAP client 100 and the CoAP server 250, have resources to share and request a certain resource from each other.

The discovery in the resource directory 200 may indicate a discovery of a location of a register function set in the resource directory 200 used to register a resource that the CoAP server 250 desires to share.

When a complete path is obtained for the register function set in the resource directory 200, the CoAP server 250 may register or publish the resource in or to the resource directory 200.

The CoAP client 100 may request the resource directory 200 to look up for the registered resource. The resource directory 200 may return an access path for the registered resource in response to the request made by the CoAP client 100.

The returned resource may include a simple or composite resource, and the CoAP client 100 may communicate with such a resource.

A composite interaction with resources may be based on a unit ID, and the CoAP client 100 may interact with individual sub-devices or collectively interact with all the sub-devices of the composite node 330.

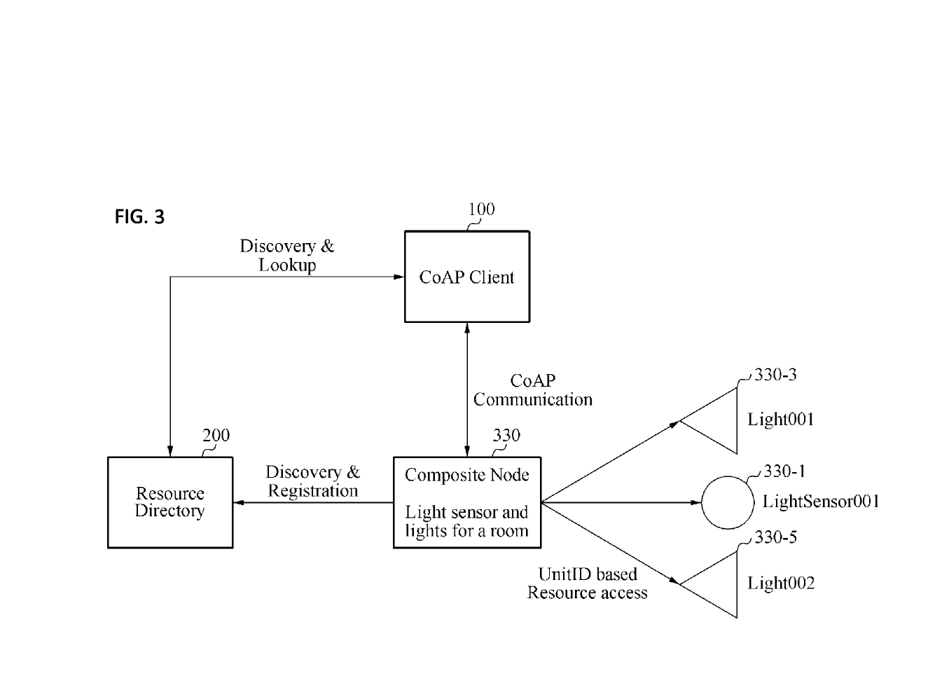

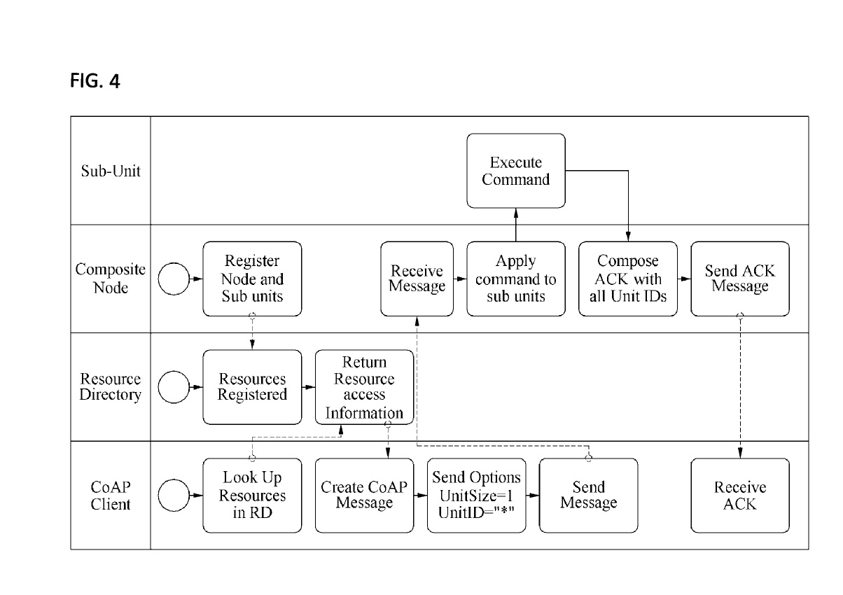

FIG. 3 is a diagram illustrating an example of an operation of identifying and controlling resources of a composite node using a unit ID according to an embodiment of the present invention. FIG. 4 is a data flow illustrating an example of message exchange between the CoAP client 100 and the composite node 330 of FIG. 3.

For ease of description, in the examples of FIGS. 3 and 4, the composite node 330 is assumed to include a light sensor 330-1 and two switches, for example, a switch 330-3 and a switch 330-5.

Referring to FIGS. 1 through 4, the composite node 330 may be accessed via a single IP address assigned to the composite node 330. Sub-resources, for example, the light sensor 330-1 and the switches 330-3 and 330-5, of the composite node 330 may be accessed with unit IDs.

The composite node 330 as a CoAP endpoint may register, in the resource directory 200, a resource in a form of a sub-unit. Thus, the resource directory 200 may have a single IP address for the composite node 330 and a unit ID for each sub-unit of the composite node 330.

The CoAP client 100 may perform lookup on the resource directory 200 and obtain required resource information.

For ease of description, the CoAP client 100 is assumed to interact with the composite node 330, and information regarding all the sub-units, for example, the light sensor 330-1 and the two switches 330-3 and 330-5, is assumed to be provided to the CoAP client 100 by the resource directory 200.

The CoAP client 100 may use the information regarding all the sub-units of the composite node 330, for example, a unit size (UnitSize) and a unit ID (UnitID), to generate a request message, for example, a CoAP message, to interact with a single sub-unit or a plurality of sub-units of the composite node 330.

For example, the CoAP client 100 may transmit a CoAP message, for example, with “UnitSize=1 and UnitID=LightSensor001,” to request data from the light sensor 330-1. The composite node 330 may return a response message, for example, an acknowledge (ACK) message, including a UnitID parameter and sensor reading as a message payload.

In addition, the CoAP client 100 may transmit, as a single message, a CoAP message including options of “UnitSize=2 and UnitID=Light001, UnitID=Light002” to turn on or off light.

Using a composite message for a unit ID may reduce a traffic flow between the CoAP client 100 and endpoints, for example, the CoAP server 250, and save energy in constrained devices.

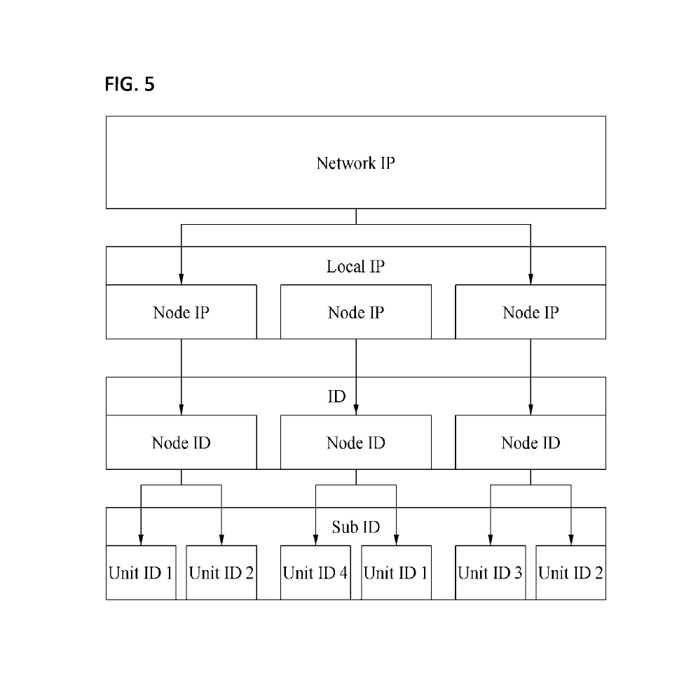

FIG. 5 is a diagram illustrating an example of IP and ID mapping based on a plurality of unit IDs according to an embodiment of the present invention.

Referring to FIG. 5, a network IP address and a local IP address may be used to access a network of a node and a physical node, respectively. In CoAP, a node ID may be used to ensure consistency of communication when a change in an IP address occurs at the client 100 or the server 250 during a communication session. Thus, a pair of the node IP address and the node ID may be used to communicate with a single resource.

The single node, for example, the composite node 330, may include a plurality of integrated resources, and each resource may be represented by a plurality of sub-IDs.

A sub-ID for an integrated resource may be referred to as a unit ID, and a single node may have at least one unit ID.

Thus, use of a single IP address for communication with a plurality of resources or units may be enabled, and each resource may be treated as a separate entity having an own unique address without having a separate IP address.

Accordingly, the communication system 10 may represent a greater number of devices through effective utilization of an IP address space by combining the node IP and the unit ID as a pair.

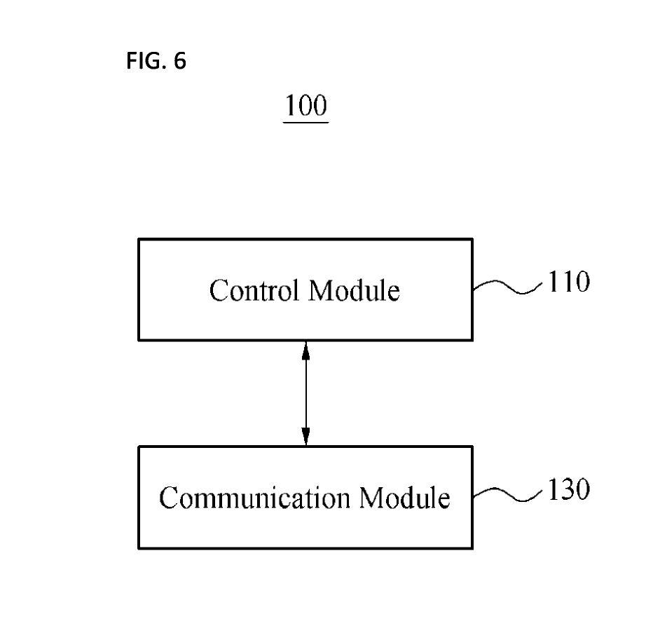

FIG. 6 is a diagram illustrating the client 100 of FIG. 1. Referring to FIGS. 1 through 6, a CoAP node, for example, the client 100, includes a control module 110 and a communication module 130.

The control module 110 generates a request message, for example, a CoAP message, to interact with a sub-unit of each node, for example, the sensor node 310, the actuator node 320, and the composite node 330.

For example, the control module 110 may generate the CoAP message to interact with a single sub-unit or a plurality of sub-units of the composite node 330 using information regarding all the sub-units, for example, the light sensor 330-1 and the two switches 330-3 and 330-5, of the composite node 330. The information regarding all the sub-units may be, for example, a unit size (UnitSize) and a unit ID (UnitID). For example, the control module 110 may generate a CoAP message of “UnitSize=1 and UnitID=LightSensor001” to request data from the light sensor 330-1.

For another example, the control module 110 may generate a CoAP message including options of “UnitSize=2, and UnitID=Light001, UnitID=Light002” as a single message to turn on or off light.

The communication module 130 transmits the request message, for example, the CoAP message, generated by the control module 110 to a node, for example, the sensor node 310, the actuator node 320, and the composite node 330.

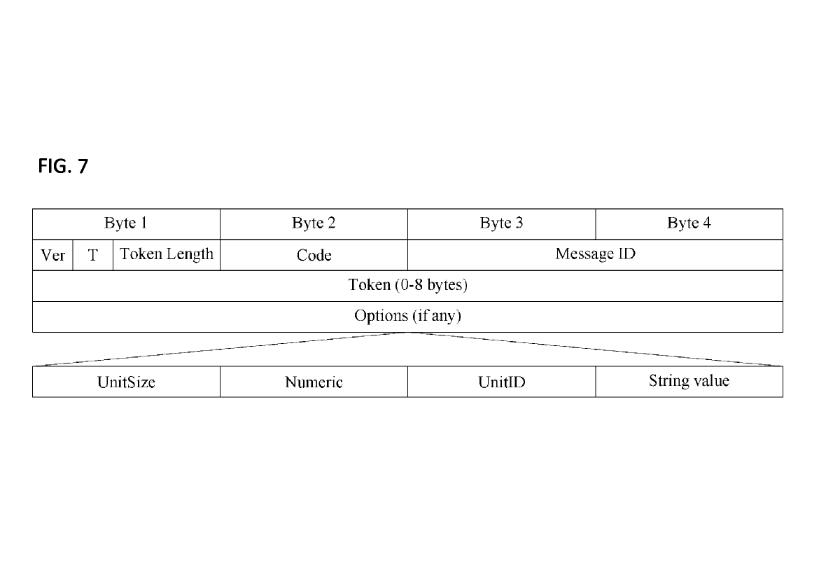

FIG. 7 is a diagram illustrating an example of a format of a CoAP message header according to an embodiment of the present invention.

Referring to FIG. 7, a header of a CoAP message includes a field, for example, a version (Ver) field, a type (T) field, and a token length field. The header also includes an option section.

In the option section, a unit size (UnitSize) field may specify a number of sub-units to be integrated into a single composite node, and a unit ID (UnitID) option may be present to hold a string ID for a unit ID representing a sub-unit in a composite node.

A UnitID field may be repeated multiple times depending on a numerical value of a UnitSize parameter, and represent a single spring ID for a sub-unit relating to a composite node each time.

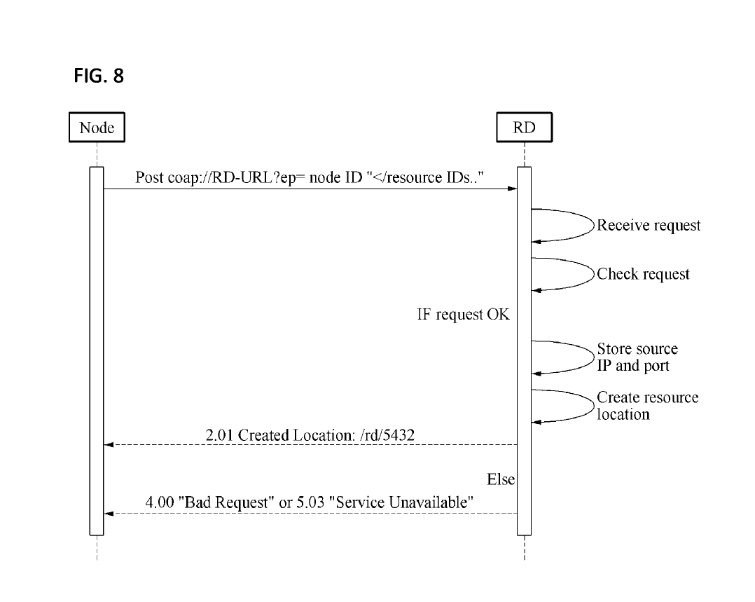

FIG. 8 is a diagram illustrating an example of registering a resource of a node in a resource directory according to an embodiment of the present invention.

Referring to FIG. 8, in order to register a node and resources integrated in the node in the resource directory, the node may transmit, to the resource directory, a CoAP POST message using a register function set of the resource directory for a registration request. A message payload may include a list of all unit IDs associated with the node.

The resource directory may receive the CoAP POST message, and verify whether the registration request is valid. For example, when the resource directory receives a valid registration request from the node, a source IP address and a port number may be obtained from a CoAP request parameter or a message source address portion, for example, a default.

The resource directory may extract the unit IDs from the message payload, generate a resource location of all the resources, and return a response message to the node.

When such a registration process is successful, a location uniform resource identifier (URI) may be returned to the node requesting the registration, and the registration of the integrated resources may be canceled by updating the registration or removing a location entry.

Conversely, when the registration process is unsuccessful, an error message may be returned to mention a cause of such a failure.

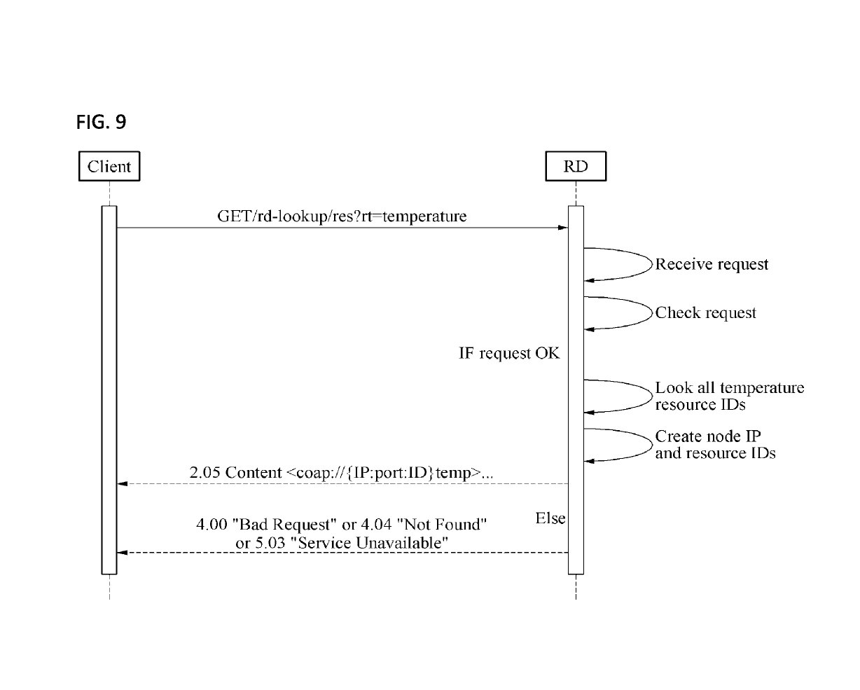

FIG. 9 is a diagram illustrating an example of a lookup process of a resource directory to be performed on an endpoint unit resource integrated into a single node, for example, a single IP address, according to an embodiment of the present invention.

In the example of FIG. 9, a client is assumed to make a request for a certain type, for example, a temperature, of a resource registered in the resource directory (RD).

Referring to FIG. 9, the client transmits, to the resource directory, a GET request, for example, a GET request message, including a resource type that the client desires to look up in the resource directory.

The resource directory receives the GET request, for example, the GET request message, verifies whether the GET request message is a valid CoAP request, and obtains IDs of all registered resources including a numerical value corresponding to the resource type, for example, the temperature.

The resource directory generates a response message including a list of the IDs of the resources and node IP addresses.

The client selects a resource from the list, and directly communicates with the selected resource using a CoAP.

When such a lookup process is not successful, an error message may be returned to mention a cause of such a failure.

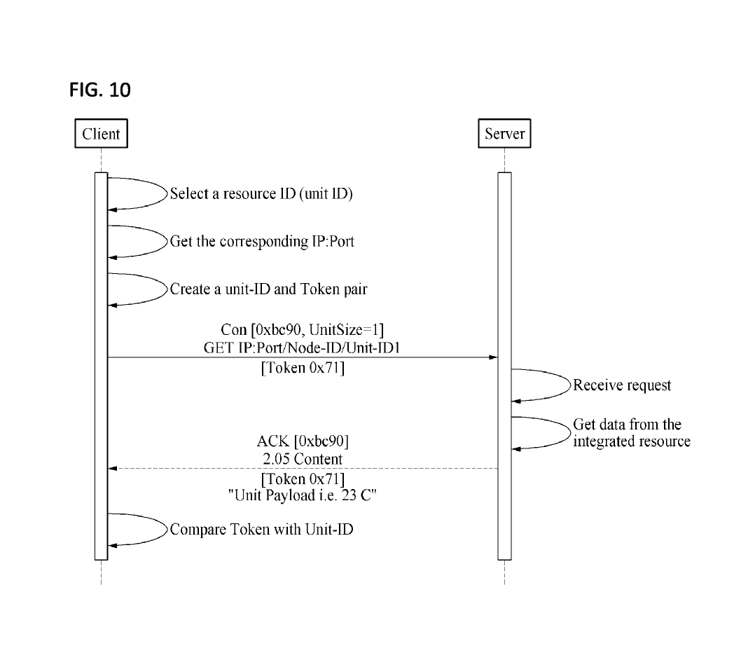

FIG. 10 is a diagram illustrating an example of interaction between a client and a resource, for example, a CoAP server, according to an embodiment of the present invention.

As described with reference to FIG. 9, the client may look up for a resource of a certain resource type in the resource directory, and obtain a list of IDs, for example, node IDs and unit IDs, of all resources registered in the resource directory.

FIG. 10 illustrates a process of selecting a resource from the list and directly communicating with the selected resource by the client.

Referring to FIG. 10, when the client interacts with a resource and the resource is a composite node, the client obtains a complete URI, for example, a node IP address, a port number, and a unit ID.

For a simple resource, for example, a sensor and an actuator, a node ID may be used along with an IP address to allow interaction between a CoAP client and a server to be performed.

For a composite resource, for example a plurality of integrated resources, the client may generate a unit ID and a token pair and transmit a GET request to a resource integrated into a node using the complete URI. A token used herein may indicate a CoAP token to be transmitted along with a general GET request.

The node, for example, the CoAP server, verifies a validity of the request, and responds to the client with an ACK including a token and data from the integrated resource. The client verifies a source of the data by comparing the token of the ACK to the stored unit ID and the token pair.

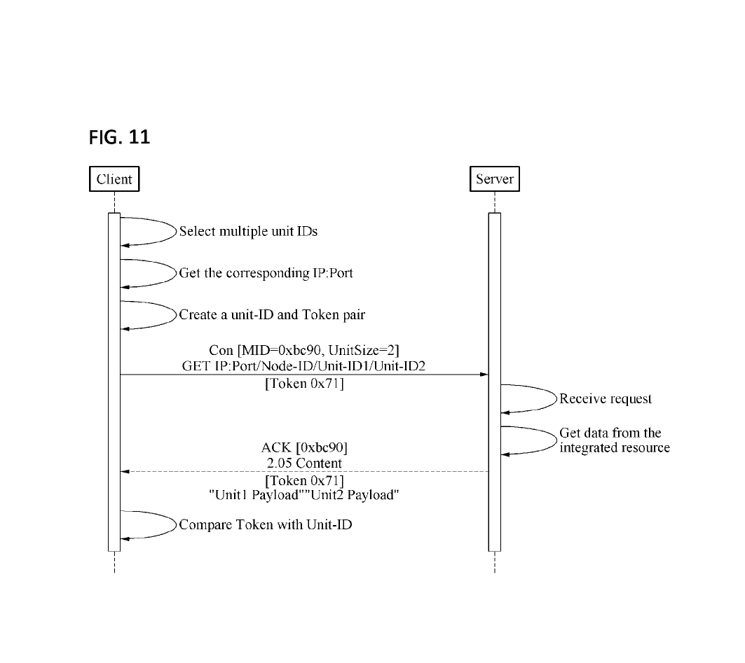

FIG. 11 is a diagram illustrating another example of interaction between a client and a resource, for example, a CoAP server, according to an embodiment of the present invention.

For ease of description, in the example of FIG. 11, both unit IDs are assumed to belong to a single node. However, a unit ID may belong to at least one CoAP node.

As described with reference to FIG. 9, the client may look up for a resource of a certain resource type in the resource directory, and obtain a list of IDs, for example, node IDs and unit IDs, of all resources registered in the resource directory.

FIG. 11 illustrates a process of selecting a resource from a list provided by the resource directory for the client to interact with a plurality of unit resources.

Referring to FIG. 11, the client selects a complete URI, for example, a node IP address, a port number, and a unit ID, for communication, and generates and stores the unit ID and a token pair. A token used herein may indicate a CoAP token to be transmitted along with a general GET request.

The client transmits a GET request to resources integrated into a single or at least one node using the complete URI, for example, a node IP address, a port number, a node ID, and a unit ID.

In addition, the GET request including a plurality of unit IDs may include a unit size parameter indicating a number of the integrated resources.

The node, for example, the CoAP server verifies a validity of the request, and responds to the client with an ACK including a token and data from the integrated resources.

The client verifies a source of the data by comparing the token of the ACK to the stored unit ID and the token pair.

The various modules, elements, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Functional programs, codes, and code segments for implementing the examples disclosed herein can be easily constructed by a programmer skilled in the art to which the examples pertain based on the drawings and their corresponding descriptions as provided herein.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A constrained application protocol (CoAP) communication method, comprising:
selecting a unit identifier (ID) of at least one resource from a list; and
generating the unit ID and a token pair and transmitting a GET request to the resource using a uniform resource identifier (URI).

2. The method of claim 1, further comprising:
obtaining a node Internet Protocol (IP) address and a port number of a node comprising the at least one resource.

3. The method of claim 2, wherein the GET request comprises the node IP address, the port number, and the unit ID.

4. The method of claim 3, wherein the GET request further comprises a unit size associated with a number of the at least one resource.

5. The method of claim 1, further comprising:
receiving an acknowledgement (ACK) comprising data and a token transmitted from the resource, and verifying a source of the data by comparing the token of the ACK to the unit ID and the token pair.

6. A constrained application protocol (CoAP) node, comprising:
a control module configured to select a unit identifier (ID) of at least one resource from a list, and generate the unit ID and a token pair and generate a GET request; and
a communication module configured to transmit the GET request.

7. The node of claim 6, wherein the control module is configured to obtain a node Internet Protocol (IP) address and a port number of a node comprising the at least one resource.

8. The node of claim 7, wherein the GET request comprises the node IP address, the port number, and the unit ID.

9. The node of claim 8, wherein the GET request further comprises a unit size associated with a number of the at least one resource.

10. The node of claim 6, wherein the control module is configured to receive an acknowledgement (ACK) comprising data and a token transmitted from the resource, and verify a source of the data by comparing the token of the ACK to the unit ID and the token pair.

11. A constrained application protocol (CoAP) message header, comprising:
a field comprising version information, type information, and length information of a CoAP message; and
an option section comprising a unit identifier (ID) field representing at least one resource associated with a node.

12. The CoAP message header of claim 11, wherein the option section further comprises a unit size field representing a number of the at least one resource.

13. The CoAP message header of claim 12, wherein the unit ID field is configured to repeat by the number of the at least one resource of the unit size field.
